(19) United States
(12) Patent Application Publication
(10) Pub. No.: US 2023/0141964 A1
(43) Pub. Date: May 11, 2023

(54) Multi-Level Cache System For Reduction Of Storage Costs

(71) Applicant: Elasticsearch B.V., Mountain View, CA (US)

(72) Inventors: Yannick Welsch, Junglinster (LU); David Christopher Turner, Otley (GB); Armin Braun, Schwyz (CH); Tanguy Leroux, Lyon (FR); Henning Andersen, Midtjylland (DK); Francisco Fernández Castaño, Utrecht (NL); Matthew Lee Hinman, Aurora, CO (US); Jason Tedor, Avon, OH (US)

(21) Appl. No.: 17/522,724

(22) Filed: Nov. 9, 2021

(51) Int. Cl. G06F 12/0802; G06F 16/903

(52) U.S. Cl. CPC G06F 12/0802; G06F 16/90335; G06F 2212/60

(57) ABSTRACT

Provided are systems and methods for multi-layer caching of data. An example method commences with creating a data structure on top of an information retrieval library. The data structure is designed to access data associated with the information retrieval library through a local index. The method includes creating a plurality of ordered cache layers for the data accessed via the local index. The plurality of ordered cache layers are ordered based on frequency of access and a last layer is used to access the data over a network. The method then continues with receiving a search query. The method further includes determining that the search query is for the data associated with the last layer. The method further continues with executing, using the local index, the search query locally to retrieve a matching document from the data associated with the last layer remotely.

### TECHNICAL FIELD

This disclosure relates to data processing. More specifically, this disclosure relates to systems and methods for multi-layer caching of data.

### BACKGROUND

There exist multiple solutions for processing queries that decouple storage from compute structure. However, the existing solutions typically abstract files at the filesystem level, resulting in querying a large amount of already indexed data that is either too large or too costly to be queried on a single cluster. Moreover, existing solutions do not support searches with large files stored remotely while executing the searches at the local file level.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Generally, the present disclosure is directed to systems and methods for multi-layer caching of data. According to one example embodiment of the present disclosure, a method for multi-layer caching of data is provided. The method may commence with creating a data structure on top of an information retrieval library. The data structure may be designed to access data associated with the information retrieval library through a local index. The method may further include creating a plurality of ordered cache layers for the data accessed via the local index. The method may continue with receiving a search query. The method may determine that the search query is for the data associated with the last layer. The method may further continue with executing, using the local index, the search query locally to retrieve a matching document from the data associated with the last layer remotely.

According to another embodiment, a system for multi-layer caching of data is provided. The system may include at least one processor and a memory communicatively coupled to the processor and storing instructions executable by the at least one processor to perform the above-mentioned method, wherein the processor can be configured to implement the operations of the above-mentioned method for multi-layer caching of data.

According to yet another aspect of the disclosure, provided is a non-transitory computer-readable storage medium, which embodies computer-readable instructions. When the computer-readable instructions are executed by a computer, they cause the computer to implement the above-mentioned method for multi-layer caching of data.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF DRAWINGS

Exemplary embodiments are illustrated by way of example and not limitation in the figures of the accompanying drawings, in which like references indicate similar elements.

FIG. 1 shows a block diagram of an environment, in which a system and a method for multi-layer caching of data can be implemented, according to an example embodiment.

FIG. 2 shows a schematic diagram illustrating a plurality of ordered data tiers for data accessed by a system, according to an example embodiment.

FIG. 3 depicts an example template for applying a low-level Application Programming Interface (API) to make snapshots searchable, according to various embodiments.

FIG. 4 is a block diagram illustrating caching latency, according to an example embodiment.

FIGS. 5A and 5B are block diagrams, which illustrate caching, according to an example embodiment.

FIG. 6 is a block diagram illustrating postings, document values, and stored fields, according to an example embodiment.

FIG. 7 is a schematic diagram illustrating an amount of space occupied by fields, according to an example embodiment.

FIGS. 8A and 8B show tables that represent an event-based data set of web server logs used by a system for multi-layer caching of data for benchmarking features.

FIG. 9 is a flow chart of an example method for multi-layer caching of data, according to some example embodiments.

FIG. 10 illustrates an exemplary computer system that may be used to implement some embodiments of the present disclosure.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The technology described herein relates to systems and methods for multi-layer caching of data. Specifically, the disclosure is directed to decoupling storage from compute and storing large files remotely on a cheaper storage service and executing compute locally in an efficient way using the library file formats optimized for searches. The systems and methods have the ability to execute concurrent search queries using an information retrieval library where files are stored in a remote object store instead of a local filesystem. Another unique ability of the systems and methods includes using different cache mechanisms to satisfy information retrieval library read operations, while metadata files are fully cached locally, some other larger files are retrieved on demand.

The lifecycle of user data is organized through the use of data tiers, also referred herein to as tiers. The data tiers are created by assigning roles to the nodes of a cluster to form one of the following tiers: hot, warm, cold, and frozen. The system provides a hot tier for fast enriching, indexing, and searching at the cost of storage space and memory. The system provides a warm tier for data accessed relatively often but with lower expectations on performance so that less costly hardware can be used to store them. The system provides a cold tier that allows storing up to twice the data on the same amount of hardware over the warm tier by eliminating the need to store redundant copies locally. The frozen tier (also referred herein to the last data tier or simply the last tier) takes it a big step further by removing the need to store any data locally at all. Embodiments of present disclosure may utilize different cache mechanisms operating on frozen tiers and cold tiers. Instead of storing data locally, the frozen tier relies on external object storage services in order to store an unlimited amount of data at a very low cost. The frozen tier then accesses the data on demand to execute search queries without any need to fully rehydrate it first. This on-demand access relies on two building blocks: a custom implementation of an information retrieval library (e.g., Apache Lucene™ Directory) and a multi-layer cache mechanism. Thus, the frozen data tier allows the execution of search queries on large volumes of data while reducing storage costs by relying on a multi-level cache system. The combined usage of the custom directory implementation and the multi-layer cache mechanism makes the last data tier unique and innovative.

Referring now to the drawings, various embodiments are described in which like reference numerals represent like parts and assemblies throughout the several views. It should be noted that the reference to various embodiments does not limit the scope of the claims attached hereto. Additionally, any examples outlined in this specification are not intended to be limiting and merely set forth some of the many possible embodiments for the appended claims.

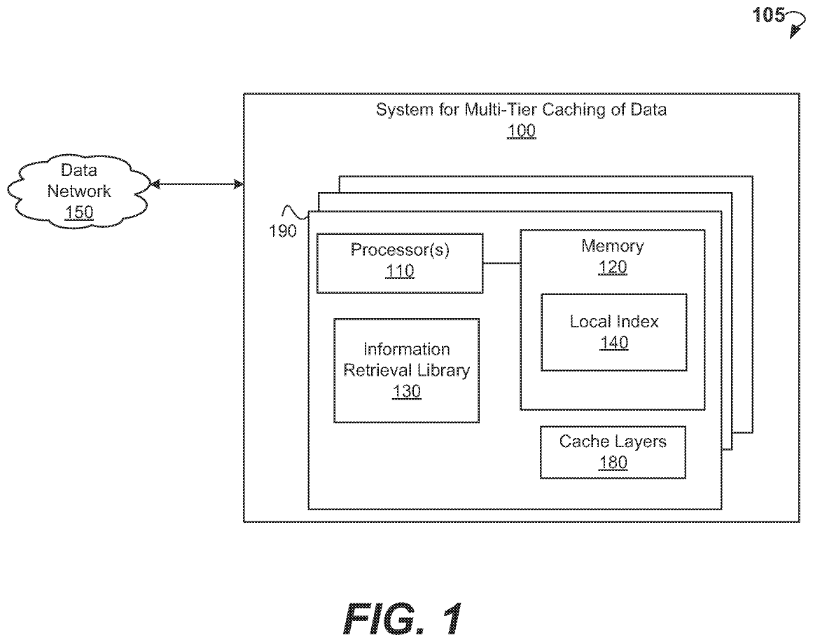

FIG. 1 shows a block diagram of an environment 105, in which a system 100 for multi-layer caching of data and a method for multi-layer caching of data can be implemented. It should be noted, however, that the system 100 is just one example and is a simplified embodiment provided for illustrative purposes, and reasonable deviations of this embodiment are possible as will be evident to those skilled in the art.

As shown in FIG. 1, the system 100 may include one or more nodes 190. A node of the nodes 190 may include processors 110 and a memory 120 communicatively coupled to the one or more processors 110. The memory 120 may store a local index 140. The local index 140 may be stored in the memory 120. The node may generate data structure to host the local index 140. The data structure can be designed to access data associated with an information retrieval library 130. The information retrieval library 130 may implement a customized data structure to access the required files from the local index. The customized directory structure may utilize different cache mechanisms to access data in the local index 150. Each of the nodes 190 can be assigned to one of the following data tiers of user data: a hot tier, a warm tier, a cold tier, or a frozen tier. The data tiers are based on the lifecycle and age of the local index 140. Nodes having the highest rates and costs of processors 110 and memories 120 can be assigned to the hot tier. Nodes having the highest rates and costs of processors 110 and memories 120 can be assigned to the frozen tier.

In an example embodiment, the processors 110 may be configured to create a plurality of ordered cache layers for the data accessed via the local index 140. The plurality of ordered cache layers 180 may be ordered based on frequency of access. The nodes can be configured to receive search queries via a network shown as a data network 150.

In an example embodiment, the data network 150 can refer to any wired, wireless, or optical networks including, for example, the Internet, intranet, local area network (LAN), Personal Area Network, Wide Area Network (WAN), Virtual Private Network, cellular phone networks (e.g., a Global System for Mobile (GSM) communications network, a packet switching communications network, a circuit switching communications network), Bluetooth® radio, an Ethernet network, an IEEE 802.11-based radio frequency network, a Frame Relay network, an Internet Protocol (IP) communications network, or any other data communication network utilizing physical layers, link layer capability, or network layers to carry data packets, or any combinations of the above-listed data networks. In some embodiments, the data network 150 includes a corporate network, a data center network, a service provider network, a mobile operator network, or any combinations thereof.

The processors 110 may be configured to receive a search query and determine that the search query is for the data associated with the last tier. The processors 110 may be further configured to execute the search query using the local index 140 locally to retrieve a matching document from the data associated with the last tier remotely.

In an example embodiment, more frequently accessed parts of the data may be stored primarily locally and less frequently accessed parts of the data may be stored primarily remotely. When the search query is executed, the files are accessed depending on a type of data indexed and a type of a search performed. In an example embodiment, the less frequently accessed parts can be evicted from the local disk. In an example embodiment, a Least Frequently Used (LFU) algorithm may be used to keep the more frequently accessed parts of the data in a local cache while evicting less frequently accessed parts of the data to a remote storage.

In an example embodiment, upon creating the local index 140, the information retrieval library 130 may create files on a local disk. Each file of the files may have a specific format to optimize different types of search queries. Nodes of the last tier may share the local index 140. The local index 140 may be used to store beginnings and ends of the files.

The files may be available in the local index 140 and may be automatically replicated within a cluster. The files may be available when a node of the last tier opens the local index 140, thereby speeding up startup time of opening the local index 140. Every node of the last tier may include a second layer of cache for caching the files on the local disk.

In an example embodiment, upon access of the matching document stored remotely, larger parts of the document maybe cached locally in anticipation of further access.

In an example embodiment, the system 100 may be built on top of Apache Lucene™, a well-known information retrieval library. The information retrieval library 130 allows indexing documents and then execute search queries to retrieve matching documents.

When documents are indexed in the information retrieval library 130, the information retrieval library 130 creates multiple files on a disk. These files have specific formats to optimize different types of search queries that can be done using the information retrieval library 130. Specifically, some files consist of a sorted list of terms like a dictionary, some files are optimized to speed up searches on geospatial coordinates, other files contain the original document as a whole, and so forth.

The files can be organized in groups of files known as segments, and one or more segments compose the local index 140. The local index 140 is the top-level structure required by the information retrieval library 130 to execute a search query and to index documents. When the system 100 executes a search query, the system 100 accesses the files of the local index 140 in different ways depending on the type of data indexed and the type of search performed. For example, the system 100 can read some metadata files only once, byte after byte, from the beginning to the end of the file. In another embodiment, the system 100 can read terms dictionary at random places in the file depending on the term for which the system 100 is looking.

The data structure used to access files is implemented as a directory. The information retrieval library 130 provides default implementations for directories which are all designed to access a local filesystem, and as such requires all the data to be available on disk. The frozen tier 220 uses a specific directory implementation to access files in the information retrieval library 130. In an example embodiment, the directory may be called a searchable snapshots directory.

The system 100 can be used to access files remotely over the data network 150. The conventional default directories rely on local filesystems, while the system 100 allows accessing files that are not stored locally on a disk but rather on remote storage. The system 100 optimizes file access by caching data locally. The directory relies on a multi-level cache mechanism to keep the parts of the files that are most often accessed locally. The layers of multi-level cache can include: a system index storing beginnings and ends of files, a cache calculated based on sparse files for the local index, and a cache calculated based on a single file exceeding a pre-determined size and shared between local indexes of multiple nodes corresponding to the frozen tier. The multi-level cache is bounded in size such that the least frequently used files are evicted when the directory requires space to store a new file chunk.

Another innovative ability of the system 100 relates to optimizing file access over the data network 150. The directory takes care of downloading the right portion of a file (not the complete file) to satisfy the read operation the system 100 executes. Because requests to object storage services (such as Amazon S3®) usually have a high latency, the system 100 can implement a specific readahead strategy. The system 100 can assume that it will require more bytes from the same file so the system downloads a larger portion of each file in prevision.

One more innovative ability of the system 100 relates to supporting concurrent file access. The system 100 makes use of dedicated thread pools to allow concurrent search execution while all downloads are executed asynchronously in the background. The system 100 implements a complex locking mechanism to detect part of files that must be downloaded and part of files that can be read as soon as the data is available in cache.

The system 100 takes care of coordinating the read operations required by the information retrieval library 130 to execute concurrent search queries with the download operations necessary to retrieve the data that are not available locally.

Once downloaded, the data are stored in a multi-layer cache composed of:
a first layer of cache implemented as the system index;
a second layer implemented as dedicated cache files on disk; and
a third layer implemented as a single shared cache file on disk.

The system index. Nodes of the system 100 that compose the frozen tier 220 share a system index, which can be named “.snapshot-blob-cache.” The system index is used to store the beginning and the end of some files. Therefore, the system index can be used to cache parts of files.

The files stored in this cache are the files that are always accessed when the information retrieval library 130 opens an index. Having such files available in the local index 140, which is automatically replicated within the cluster, makes the files likely to be available when a node of the frozen tier opens an index, drastically speeding up the “startup” time of opening the local index 140. This cache layer works conjointly with the custom directory implementation to populate the local index 140.

Dedicated cache files on disk. Every node that composes the frozen tier contains a second layer of cache that only caches metadata files on disk. The files cached at this level are typically small files that contain pointers to other larger files, each metadata file being stored on the local disk as a dedicated file. This second cache layer works conjointly with the custom directory implementation to write cache files on disk in a non-blocking way.

Shared cache file on disk. Every node that composes the frozen tier contains a third layer of cache that consists of a single cache file. This cache file takes a configurable amount of local disk space, up to 90% by default, and is used to cache chunks of all other files. This cache file is shared between all indices that exist on the node and is divided into multiple regions of, for example, 16 MB each. Since the cache has a bounded size, it may not be large enough to contain all files for all indices, such that the system uses a Least Frequently Used (LFU) algorithm to keep frequently used parts of files in cache while evicting the least frequently used parts of files when more space is needed. This third cache layer works conjointly with the custom directory implementation to write cache files on disk in a non-blocking way. Thus, the combined usage of the directory implementation and the multi-layer cache mechanism makes the frozen data tier of the system 100 unique.

In general, the system 100 uses snapshots as data backups to low-cost object stores. Searchable snapshots make that same snapshot data in the object store directly available to searches. Snapshots are used to create backups of the data in a cluster to low-cost object stores such as, for example, Microsoft Azure®, Amazon S3®, Google Cloud Storage®, as well as to distributed filesystems such as Hadoop HDFS®, and the like. The system 100 allows using these same snapshots in the object stores to directly power searches.

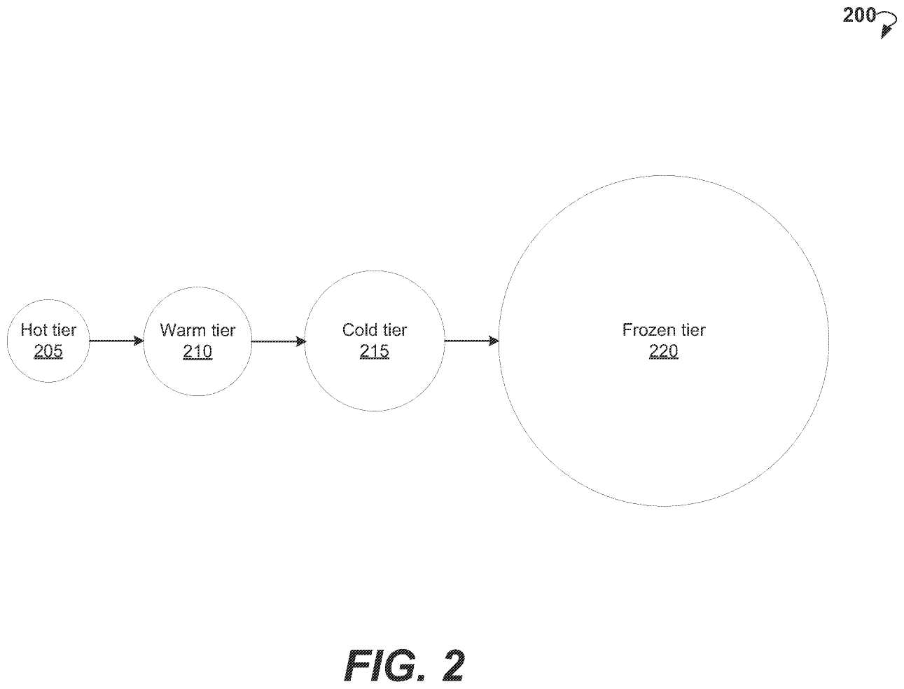

FIG. 2 shows a schematic diagram 200 illustrating a plurality of ordered data tiers for the data accessed by the system 100 via the local index, according to an example embodiment. The ordered data tiers include a hot tier 205, a warm tier 210, a cold tier 215, and a frozen tier 220. The cost of storing data in the hot tier 205 may be up to about XXX $ (a three-digit cost), the cost of storing data in the warm tier 210 may be up to about X $ (a one-digit cost), the cost of storing data in the cold tier 215 may be up to about X/2 $ (a one-digit cost divided by 2), and the cost of storing data in the frozen tier 220 may be up to about X/20 $ (a one-digit cost divided by 20). The cold tier 215 can cache a full copy of the data on local disks in the cluster of nodes 190. The frozen tier 220 caches only small parts of the data locally in the cluster.

In an example embodiment, the data may include time series data, such as logs, metrics, traces, security events, and so forth. If several terabytes of log data are collected per day, for example, this can quickly amount to a petabyte of data per year. The problem is to find a way to cost-effectively manage these data volumes while still having the ability to efficiently search on them.

The system 100 provides a solution to this problem by providing data tiers, which provide adapted levels of storage and processing power at each of the stages of the data lifecycle. The hot tier 205 handles all ingestion of new data in the cluster and holds the most recent daily indices that tend to be queried most frequently. As ingestion is a central processing unit (CPU) and input/output (I/O) intensive activity, the hardware these nodes run on needs high amounts of compute power and fast disks. In contrast, the warm tier 210 can handle older indices that are less frequently queried, and can therefore instead use very large spinning disks and less CPU cores. This reduces the overall cost of retaining data over time yet making it still accessible for queries.

With searchable snapshots (i.e., backups of the data in a cluster), the system 100 can provide two new, cheaper and more powerful data tiers that leverage low-cost object stores.

The idea of the cold tier 215 is to eliminate the need to keep multiple copies of the data on local disks. In the hot tier 205 and the warm tier 210, half of the disk space can be used to store replica parts. These redundant copies ensure fast and consistent query performance and provide resilience in case of machine failures, where a replica takes over as the new primary data.

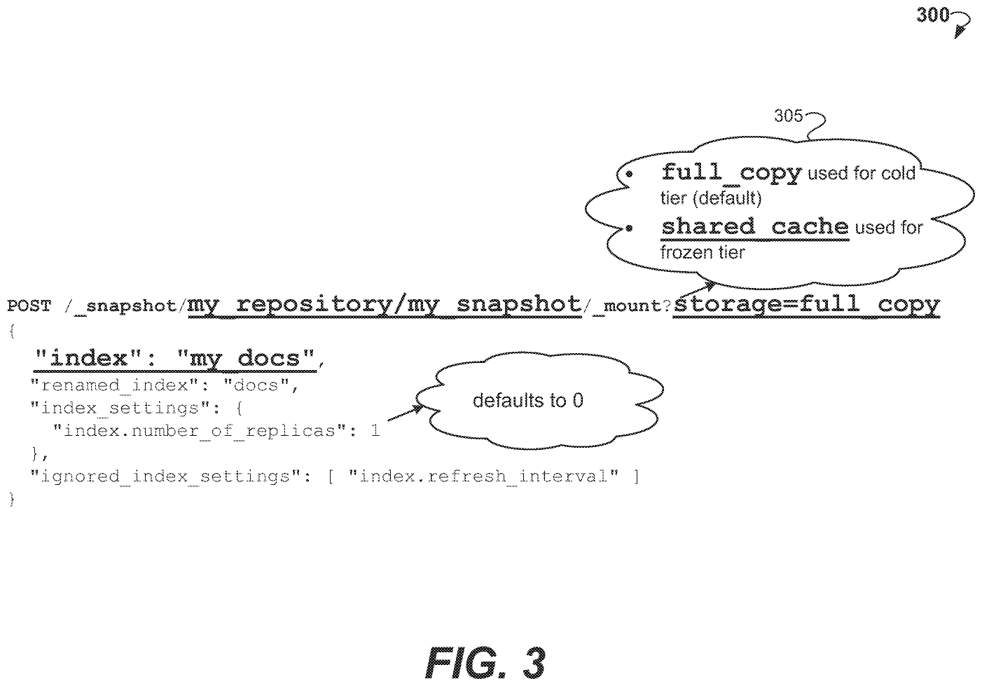

FIG. 3 depicts an example template 300 for applying a low-level API to make snapshots searchable, according to various embodiments. The API is also called a mount API. The full copy 305 is used for the cold tier (default), and a shared cache is used for the frozen tier 220.

When mounting an index from a snapshot using the mount API, the system 100 creates a fresh index in the cluster that is backed by the data in the snapshot, and the system 100 allocates parts for this newly created index to the data nodes in the cluster. This allows interacting with the data in the snapshot as if it were a regular index. It means that there is no need to worry that the data is stored in the snapshot, it allows doing any and all operations on a regular index, slicing and dicing the data whichever way is needed. When invoking the mount API, a repository name and a snapshot name are provided as parameters where the data is located. The name of the index that is to be mounted into the cluster is specified in the request body.

To distinguish between indices targeting the cold tier or the frozen tier, the mount API can have a parameter called “storage”, for example. If the mount API is set to “full_copy” 305, each node holding a part of the index makes a full copy of the data from the snapshot to its local storage. If the mount API is set to “shared_cache”, the part of data is not a full copy of the data but instead only parts of the data are cached in a node-local shared cache, which allows for very flexible compute to storage ratios (what is used for the frozen tier).

If the system 100 uses the Indices Lifecycle Management (ILM) to move the data between data tiers (e.g., warm to cold), there is no need to directly invoke this API, but ILM can internally make use of this API, e.g., first take a snapshot of the index in the warm tier, and then mount that snapshot in the cold tier.

The three key ingredients for why the system 100 is fast are a multi-layer caching infrastructure, optimized data access patterns, and optimized data storage formats.

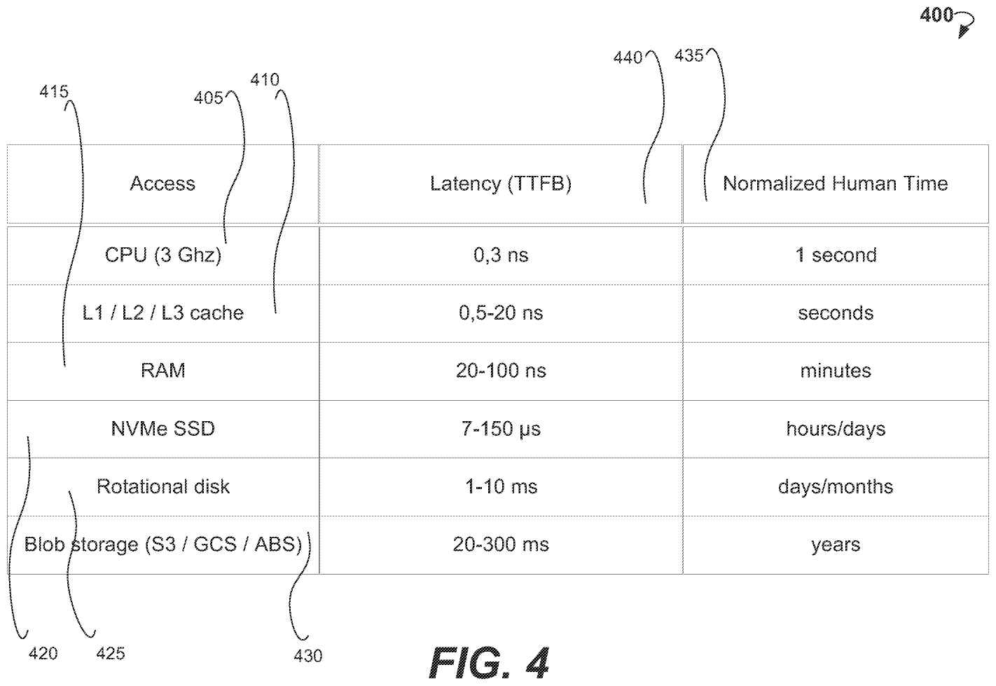

FIG. 4 is a block diagram 400 illustrating caching latency 440 (Time To First Byte (TTFB)), according to an example embodiment. FIG. 4 shows the CPU 405 registers and a hierarchy 410 of cache levels that reside on the processor (L1, L2, and L3) and that can be accessed within nanoseconds. Accessing dynamic random access memory 415 (also called main memory, or RAM for short) can already take many CPU 405 clock cycles, even on modern systems. Furthermore, there are Non-Volatile Memory Express (NVMe)-connected Solid State Drives 420 which, while extremely fast, are still orders of magnitude slower than main memory, namely microseconds instead of nanoseconds. Rotational disks 425 are yet another order of magnitude slower, with accesses taking milliseconds. The blob storage 430, e.g., S3®/Google Cloud Storage®/Azure® blob storage, may experience latency of tens or hundreds of milliseconds, even when accessing the cloud storage via an instance in the respective cloud providers compute environments. The motivation for this layered architecture is simple: physics and cost. Each layer allows storing data more and more cost-effectively, while introducing increased latency.

To put the numbers in FIG. 4 into a more human perspective, the right column 435 illustrates normalizing a single CPU 405 clock cycle from 0.3 nanoseconds to 1 second. In this more human consumable form, it is easier to understand the order of magnitude differences in data retrieval delay between the different accesses. The latency of accessing blob storage 430 can amount to years compared to a normalized second latency of a CPU 405 clock cycle.

Latency is not the only factor to consider when working with blob stores. The blob stores can have other peculiarities, and differ quite a bit from local filesystems. The first thing to note is that blob stores are typically optimized for large sequential reads and writes, not random access. Fortunately, all of them allow accessing parts of a blob or file via HTTP range headers, where it is possible to specify start and end byte offsets of the range to be fetched.

The second thing to note is that blob stores generally provide good throughput, and scale well with the number of clients. However, blob stores typically throttle bandwidth on the per-connection level. On S3® for example, it is possible at most download 90 MB/s per connection. Similar limitations can be observed on the other cloud providers. This means that to truly make full use of the available network bandwidth on the compute instances, there is a need to open multiple connections and parallelize the work (e.g., by fetching multiple subranges in parallel).

The third thing worth considering is that latency is generally high, in the two to three digit millisecond range. The latency means time to receiving the first byte. This high latency can be offset by requesting more bytes at once.

The fourth thing worth considering is that, next to the storage costs, there is typically a per-request cost associated with retrieving the data from the Cloud storage. On S3®, this amounts to 0.04 cents per 1000 GET requests. While not a large percentage, it may matter once many millions of requests are initiated. Finally, data transfer costs also need to be considered here. For example, only data transfer from an S3® bucket to any AWS® service(s) within the same AWS® Region is free.

The system 100 allows avoiding having to repeatedly pay the price of downloading bytes from the blob store, while at the same time also avoiding doing too many small requests but rather requesting some extra bytes to amortize the costs and offset latency. This means introducing some local cache on the nodes.

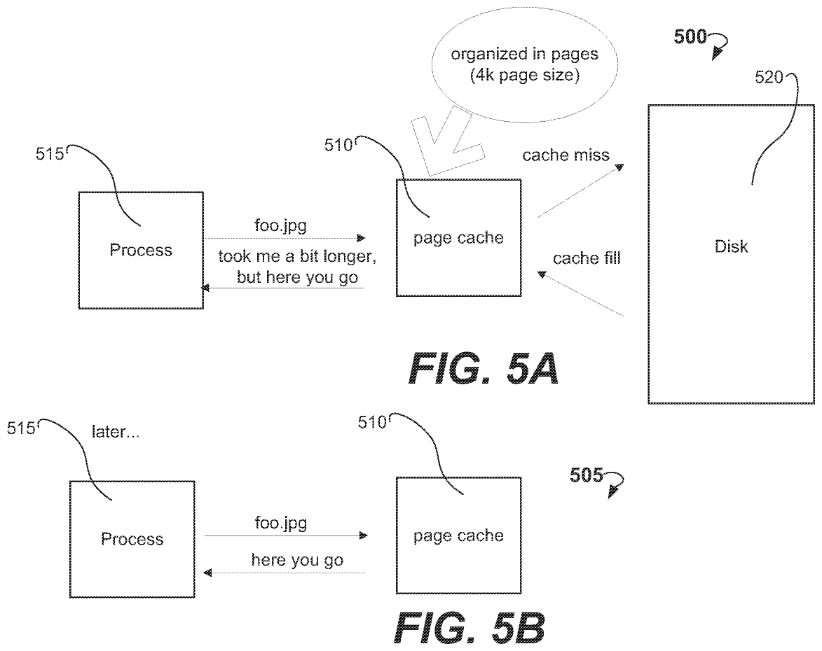

FIGS. 5A and 5B are block diagrams 500 and 505, respectively, which illustrate caching, according to an example embodiment. The page cache 510 is the main disk cache used by a process 515, for example, by the Linux® kernel, and residing in main memory. In most cases, the kernel refers to the page cache 510 when reading from or writing to disk in order to offset latency of disk seeks. It can be completely transparent to applications: when the applications read from a file on a disk 520, new pages are automatically added to the page cache 510. If the page is not already in the page cache 510, a new entry is added to the cache and filled with the data read from the disk 520. If there is enough free memory, the page is kept in the page cache 510 for an indefinite period of time and can then be reused by the same or other processes without accessing the disk 520. Pages are typically of 4 KB size and use a “least recently used” policy for eviction, which replaces the oldest entry, the entry that was accessed less recently than any other entry.

In a further example embodiment, the architecture for the searchable snapshots shared_cache, which is used by the frozen tier 220, follows similar ideas as the page cache of the operating system. The key difference is that architecture lives on disk instead of main memory. Local disks have much lower latency than blob stores, so caching data there provides faster random access and avoids repeated downloads of frequently accessed file parts.

Similar to how the page cache maps pages of 4 KB in size, the shared cache maps regions of the files in the snapshot repository to the local disk-cache in 16 MB parts. The level of granularity is at the level of regions of a file, as it is expected that some parts of these files can be accessed more frequently than other parts, depending on the query. This means that the node is not required to have enough disk space to host all the files. Instead, the shared cache manages which parts of a file are available, and which ones are not. The on-disk representation is a fixed-size pre-allocated file on which the regions are managed. If it is not persistent yet, it would not survive node restarts or crashes.

Similar to the page cache, the on-disk representation is populated on cache misses, whenever a search is accessing a given region in a file. In contrast to the page cache, which uses a “least recently used” policy, file regions are evicted in the shared cache based on a “least frequently used” policy, which works better for larger amounts of data, longer latencies, and slower throughputs.

The cache can fetch multiple regions in parallel, and can unblock readers as soon as the requested bytes are available, even before the full region has been downloaded. When reading, for example, 8 KB from a file, readers are unblocked as soon those 8 KB from the region are available. The remaining parts of the 16 MB region can still continue downloading in the background, and can then be readily available once they are requested in follow-up reads. Finally, it is also worth pointing out that the shared cache is nicely complemented by the page cache of the operating system, which avoids actual physical disk access in many cases.

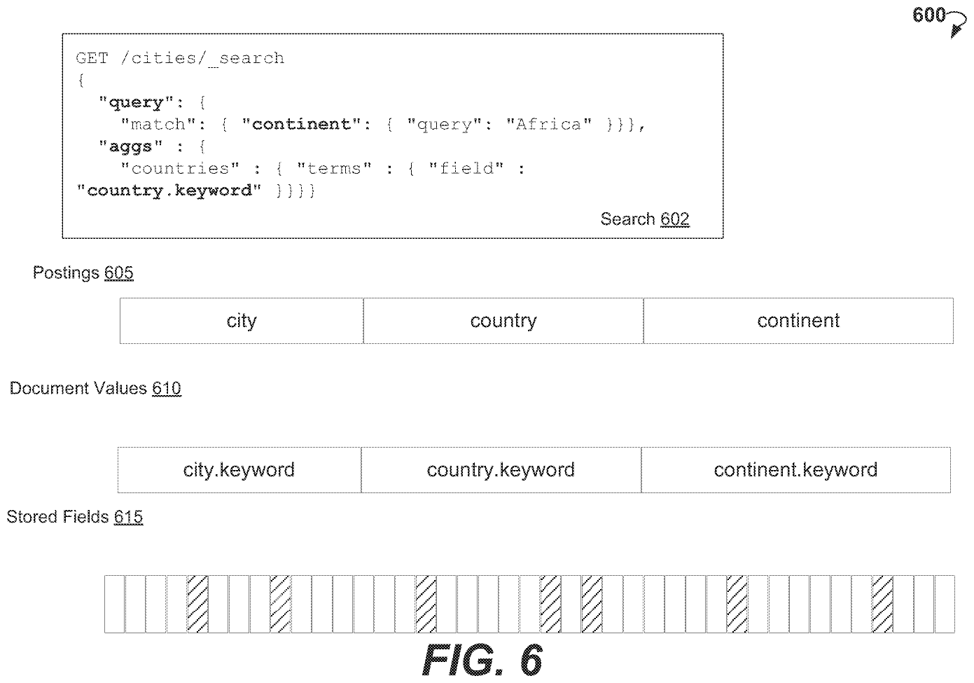

FIG. 6 is a block diagram 600 illustrating postings 605, document values 610, and stored fields 615, according to an example embodiment. FIG. 6 shows how the data storage formats and access pattern can make this cache useful. The system 100 is using the information retrieval library as underlying storage and query engine. Files of the information retrieval library are stored on the disk and in the blob store. The information retrieval library provides a powerful set of optimizations to compress the data well and make the data fast to access.

The information retrieval library uses different on-disk data structures for different access pattern. For example, the most well-known data structure of the information retrieval library is the inverted index, which is typically used for searches on text or keyword fields. There are also point structures which can be used for searches on numeric fields. There are document value structures (document values 610) which are typically used for sorting or aggregating on data. Finally, there are stored field data structures which are primarily used by the system 100 to store the full original source of the document, which is then later retrieved to populate the hits section of the search results.

The inverted index as well as document values 610 and points organize their data structures separately for each stored field 615, even if all the data structures for these different fields are ultimately stored within the same file. This means that if it is only searched or aggregated on a given field, only the region of the file that stores the relevant data structure for the given field may be accessed.

If, for example, there is a search 602 that matches all cities that are in the African continent, and the search 602 is combined with a terms aggregation that provides all unique country names. This search 602 can use the inverted index data structures of the continent field to quickly run the query part. Because the inverted index structures are consecutively stored on a per-field basis, it is sufficient to access the file region that has the inverted index for the continent field. In fact, it is not even necessary to access the full file region that has the inverted index, a subset of that file region is sufficient. This means that it is only needed to download a small subset of the overall index structures, and for relatively contiguous regions in the file.

For the aggregation part of the search 602, the search 602 can use the document values 610 data structures of the “country.keyword” field to quickly compute the unique countries. Document values 610 provide again a column-oriented view of the data, which means that the aggregation on the country field allows us to only download the columnar data for that field. The columnar nature of document values 610 also allows for great compression while at the same providing fast access. For example document values 610 do not store the raw bytes for each document in case of a keyword or text field. Instead, document values 610 write a separate terms dictionary containing all unique values in sorted order and then write the indexes of these values in the column store.

If the search 602 is also to return some hits (e.g., top 10 matching cities in Africa), the search 602 can use stored fields to return the identifier (ID) and original source of the top matching documents. As stored fields use row-based storage, this can see a lot more random access all over the data structure, so may benefit much less from caching. Important to note though is that stored fields typically see much less access, e.g., only retrieving source for the top 10 matching documents, which may possibly result in 10 HTTP requests to the blob store.

In summary, the advantage of having everything indexed by default in the system 100 makes searchable snapshots powerful, as it avoids doing a full scan of the data, and instead leverages the index structures to quickly return results over very large data sets by only downloading small contiguous portions of it.

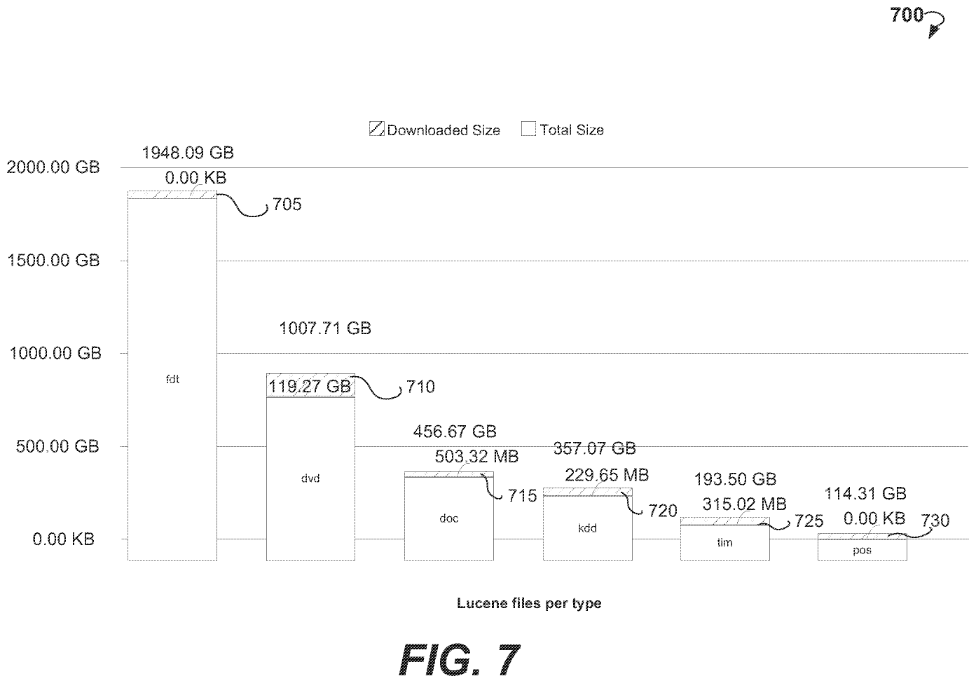

FIG. 7 is a schematic diagram 700 illustrating an amount of space occupied by each field, according to an example embodiment. FIG. 7 shows how computing (translated into bytes) is downloaded. Only a fraction of the overall data in the repository (shown as portions 705, 710, 715, 720, 725, and 730) needs to be downloaded in order to perform computing.

For performance-critical workloads, it may be important to have the full data cached. In that case, the cold tier 215 (mount option “full copy”) is best suited. The cold tier 215 creates a full local copy of the data from the repository, and persists the local copy so that it is available after crashes/restarts, making the data locally available again in no time. The cold tier 215 can use a different on-disk representation and does not need to share cache space with other shards. Instead, the cold tier 215 can use sparse files to incrementally use disk space as the data is being downloaded. The cold tier 215 also allows searches to proceed before data has been downloaded by tracking regions of files that are available to be searched, and eagerly retrieving missing requested portions of the files.

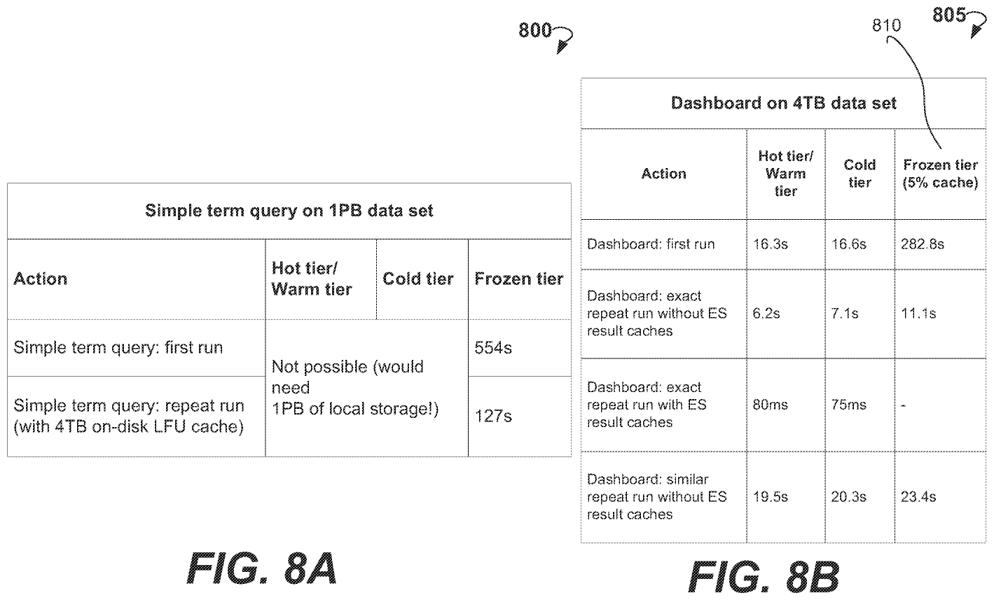

FIGS. 8A and 8B show tables 800 and 805, respectively, that represent an event-based data set of web server logs used by the system 100 for benchmarking features. For simplicity, only a single-node cluster is benchmarked, but each tier also supports multi-node clusters. The single-node cluster is an N2D® instance on Google Cloud9r) with 8 virtual CPUs, 64 GB RAM, and local Solid-State Drive (SSD) disks. It is a suitable candidate instance for frozen tier as it has fast local disks for the on-disk shared cache and a fast network connection to Google Cloud Storage®, where the snapshot data is stored.

FIG. 8A illustrates a simple term query that finds occurrences in the data set where a given IP address has accessed the web server. 12,500 shards of 80 GB each are mounted on our single-node cluster, which amounts to exactly one petabyte of data that was mounted (which is 1 million GB). Running the simple term query on that full 1 PB data set may take less than 10 minutes, showing how well the implementation scales to larger data sets.

FIG. 8B illustrates a dashboard (such as a Kibana® dashboard) that contains five visualizations and is designed to be used for analysis of requests with a 404 response code, for example, to find links that are no longer leading anywhere. This can be running on a 4 TB data set. Performance on the cold tier (which has a full local copy of data) is comparable to hot tier or warm tier. The frozen tier returns the dashboard within 5 minutes, compared to the 20 seconds it takes for the dashboard to be computed in the other tiers with local data access. Computing the dashboard only required downloading a fraction of the data in the repository thanks to the index structures (approximately 3% in this case). When the result caches of the system 100 are disabled, the performance of repeat searches mainly depends on the page cache, and is comparable in performance of the other tiers when the portions of the data needed for the query fully fits into the shared cache.

Dimensioning the shared cache on the frozen tier matters in order to achieve good performance for repeat searches. The value 810 depends on the kind of queries that are run, in particular how much data needs to be accessed to yield the query results. Having larger amounts of data mounted, therefore, does not necessarily always require a larger on-disk cache. Applying a time range filter, for example, in the context of time-based indices reduces the number of shards that need to be queried. Because there is often some kind of underlying spatial or temporal locality in data access patterns, the frozen tier may allow efficient querying on very large data sets. Based on our current observations, it is recommended sizing the on-disk cache so that it is between 1% and 10% of the mounted data set's size. A ratio of 5% is perhaps a good starting point for experimentation.

For the case where filtering is performed by a different country code, the frozen tier can benefit from having already downloaded many portions of the data that are relevant to satisfy this slightly different query, and returns results nearly as fast as the other tiers.

The second best practice is to only mount an index from a snapshot whose lifecycle is under control of the system 100. Otherwise, the backing snapshot may be unexpectedly deleted. One example solution can be a clone snapshot API associated with the system 100. The clone snapshot API can create a clone (essentially a shallow copy) of the snapshot whose lifecycle is now completely under control, and then that clone is mounted instead.

A third very important consideration is the reliability of snapshots. The sole copy of the data in a searchable snapshot index is the underlying snapshot, which is stored in the repository. If the repository fails or corrupts the contents of the snapshot then the data is lost. Although the system 100 may have made copies of the data onto local storage, these copies may be incomplete and cannot be used to recover any data after a repository failure. Fortunately, the blob storage offered by all major public cloud providers typically give very good protection against data loss and corruption.

The system 100 may also provide a number of recommendations for setting up clusters that use searchable snapshots. The first recommendation is to avoid mixing workloads by using dedicated machines for the cold or frozen tiers. The frozen tier with the shared cache in particular sees a different kind of resource usage than the typical hot or warm tier, so in order to keep performance on the ingest-heavy or more search-heavy hot tier unaffected, it is best not to have different tiers collocated on the same machine.

The second recommendation is about what instance types to use for frozen tier nodes (and how to configure the shared cache). Instance types that provide fast network access to the Cloud Storage® as well as have fast disks (e.g., local SSDs) to be best suited for the shared cache. While rotational disks seem like an interesting candidate as cache for blob storage, they deliver that great performance (especially as many parallel writes are done due to highly concurrent downloads), and having an excessively large local cache is not really helpful.

It is also needed to actually make use of the fast local disks for the shared cache. By default, 90% of the available disk space is used, or a head room of 100 GB for other stuff is left, whichever is largest.

Both vertical as well as horizontal scaling is well supported by the frozen tier, as the computations can typically be easily parallelized. Just using more performing machine types (in particular with higher network bandwidth/more CPU) or adding more nodes to the cluster is a simple way to increase query performance. For example, if it is needed to run the 1 PB query in 1 minute instead of 10, 10 nodes can be used instead of 1 or more machines can be used.

There are many more caches coming into play with searchable snapshots that make for a great overall user experience. While focusing so far on caching of the low-level data structures, the caches also come with some metadata that has an even bigger effect on search performance. When opening up a local index, some metadata is preloaded in order to allow quick access to the data in the index. The metadata is also used to determine whether some queries might not match an index at all (can_match), e.g., it contains min and max values for each field that allow for quickly skipping a shard when all of the data in the shard would not fall within the time window specified in the query.

As opening the local index is a time-critical operation (e.g., on failover), the necessary metadata need to be made available as quickly as possible. For this, hitting the blob store is avoided. Therefore, a persistent distributed cache is introduced using the local index. The local index stores the relevant metadata that allows to quickly opening up the local index and is populated on cache miss.

This means that in case of a failover, the data can be reallocated to a different node and the necessary metadata can then be quickly retrieved from the local index to allow the local index to be reopened and getting the data back to green (i.e., ready to serve search requests).

Another optimization is that more dense setups are provided with the shared_cache option (as compute to storage ratios are more flexible). To reduce the footprint of the data when the data are not actively being searched, a special data implementation is sued that closes the underlying local index when it is not actively being used. The local index is only opened when it is actively being searched, which only incurs a small performance penalty.

The local index caches the metadata in a way that does not require opening up the index to determine whether a search is applicable at all to the given shard, so it still allows to quickly skip data parts.

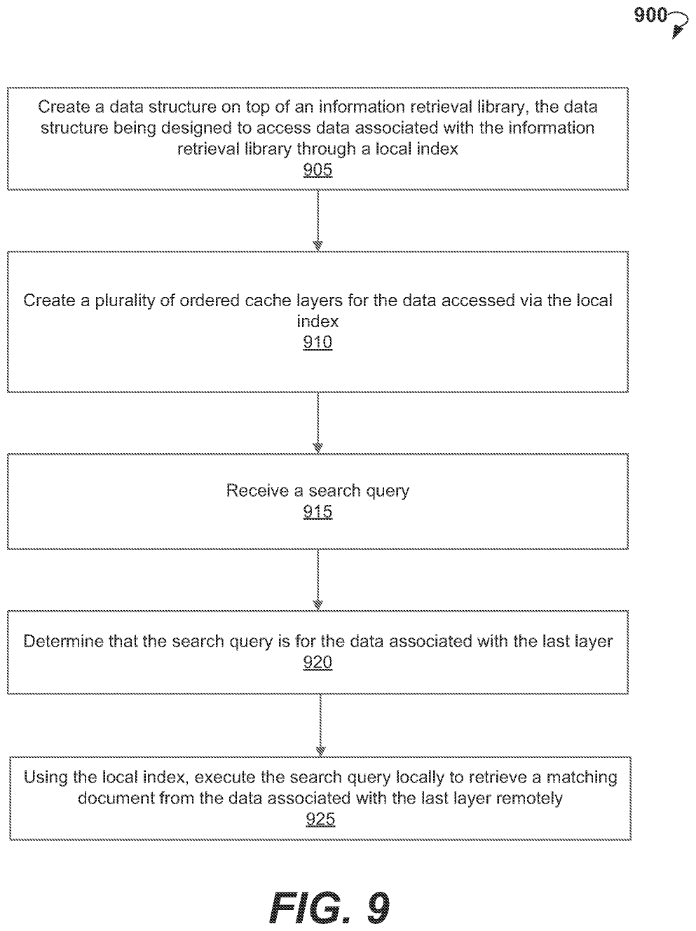

FIG. 9 is a flow chart of an example method for multi-layer caching of data, according to some example embodiments. The method 900 can be performed in an end point 100 illustrated in FIG. 1 by the system for multi-layer caching of data 150 of the end point 100. Notably, the steps recited below may be implemented in order other than described and shown in the FIG. 9. Moreover, the method 900 may have additional steps not shown herein, but which can be evident to those skilled in the art from the present disclosure.

The method 900 may commence with monitoring, in block 905, creating a data structure on top of an information retrieval library. The data structure may be designed to access data associated with the information retrieval library through a local index. Upon creating the local index, the information retrieval library may create files on a local disk, each file of the files may have a specific format to optimize different types of search queries.

The method 900 may then proceed with creating, in block 910, a data structure on top of an information retrieval library. The data structure may be designed to access data associated with the information retrieval library through a local index. The less frequently accessed parts may be evicted from the local disk.

The method 900 may further include creating, in block 915, a plurality of ordered cache layers for the data accessed via the local index. The plurality of ordered cache layers may be ordered based on frequency of access and a last layer is used to access the data over a network.

The method 900 may continue with receiving, in block 920, a search query. When the search query is executed, the files may be accessed depending on a type of data indexed and a type of a search performed.

The method 900 may then proceed with determining, in block 925, whether the search query is for the data associated with the last layer. Nodes of the last layer may share the local index. The local index may be used to store beginnings and ends of the files. The files may be available in the local index and be automatically replicated within a cluster. The files may be available when a node of the last layer opens the local index, thereby speeding up startup time of opening the local index.

The method 900 may further continue with executing, in block 930, by using the local index, the search query locally to retrieve a matching document from the data associated with the last layer remotely. Every node of the last layer may include a second layer of cache for caching the files on the local disk. Upon access of the matching document stored remotely, larger parts of the document may be cached locally in anticipation of further access.

The method 900 may, optionally, include using a Least Frequently Used (LFU) algorithm to keep the more frequently accessed parts of the data in a local cache while evicting less frequently accessed parts of the data to a remote storage.

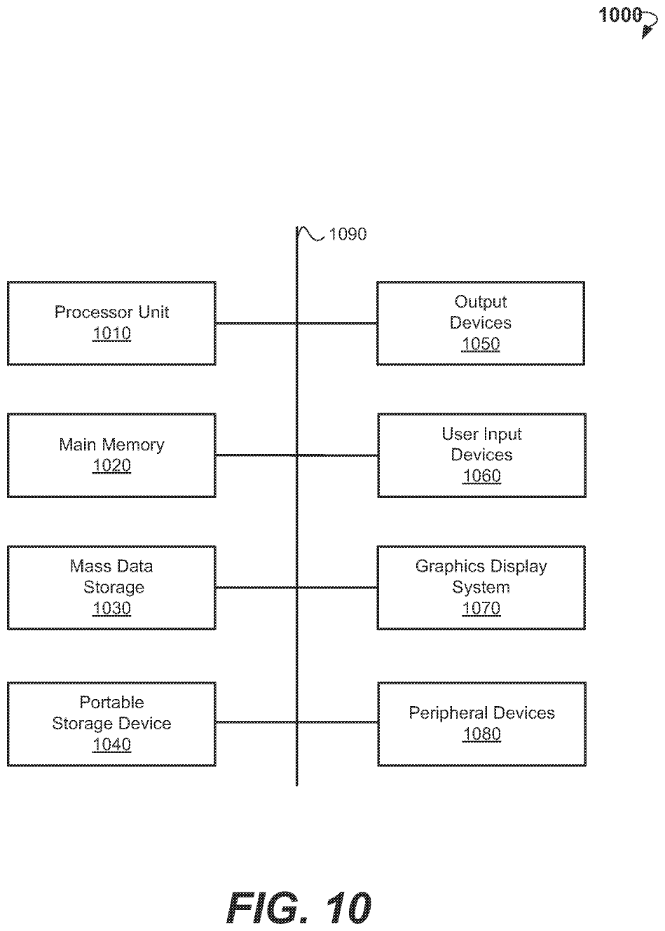

FIG. 10 illustrates an exemplary computer system 1000 that may be used to implement some embodiments of the present disclosure. The computer system 1000 of FIG. 10 may be implemented in the contexts of the end point 100 shown in FIG. 1. The computer system 1000 of FIG. 10 includes one or more processor units 1010 and a main memory 1020. The main memory 1020 stores, in part, instructions and data for execution by the processor units 1010. The main memory 1020 stores the executable code when in operation, in this example. The computer system 1000 of FIG. 10 further includes a mass data storage 1030, a portable storage device 1040, output devices 1050, user input devices 1060, a graphics display system 1070, and peripheral devices 1080.

The components shown in FIG. 10 are depicted as being connected via a single bus 1090. The components may be connected through one or more data transport means. The processor unit 1010 and the main memory 1020 are connected via a local microprocessor bus, and the mass data storage 1030, the peripheral device(s) 1080, the portable storage device 1040, and the graphics display system 1070 are connected via one or more I/O buses.

The mass data storage 1030, which can be implemented with a magnetic disk drive, solid state drive, or an optical disk drive, is a non-volatile storage device for storing data and instructions for use by the processor unit 1010. The mass data storage 1030 stores the system software for implementing embodiments of the present disclosure for purposes of loading that software into the main memory 1020.

The portable storage device 1040 operates in conjunction with a portable non-volatile storage medium, such as a flash drive, floppy disk, compact disk, digital video disc, or Universal Serial Bus storage device, to input and output data and code to and from the computer system 1000 of FIG. 10. The system software for implementing embodiments of the present disclosure is stored on such a portable medium and input to the computer system 1000 via the portable storage device 1040.

The user input devices 1060 can provide a portion of a user interface. The user input devices 1060 may include one or more microphones; an alphanumeric keypad, such as a keyboard, for inputting alphanumeric and other information; or a pointing device, such as a mouse, a trackball, stylus, or cursor direction keys. The user input devices 1060 can also include a touchscreen. Additionally, the computer system 1000 as shown in FIG. 10 includes the output devices 1050. Suitable output devices 1050 include speakers, printers, network interfaces, and monitors.

The graphics display system 1070 can include a liquid crystal display or other suitable display device. The graphics display system 1070 is configurable to receive textual and graphical information and process the information for output to the display device.

The peripheral devices 1080 may include any type of computer support device to add additional functionality to the computer system.

The components provided in the computer system 1000 of FIG. 10 are those typically found in computer systems that may be suitable for use with embodiments of the present disclosure and are intended to represent a broad category of such computer components that are well known in the art. Thus, the computer system 1000 of FIG. 10 can be a personal computer, a handheld computer system, a telephone, a mobile phone, a smartphone, a laptop computer, a mobile computer system, a workstation, a tablet, a phablet, a server, a minicomputer, a mainframe computer, a wearable device, or any other computer system. The computer system 1000 may also include different bus configurations, networked platforms, multi-processor platforms, and the like. Various operating systems may be used including UNIX®, LINUX®, WINDOWS®, MAC OS®, PALM OS®, QNX®, ANDROID®, IOS®, CHROME®, TIZEN®, and other suitable operating systems.

The processing for various embodiments may be implemented in software that is cloud-based. In some embodiments, the computer system 1000 is implemented as a cloud-based computing environment, such as a virtual machine operating within a computing cloud. In other embodiments, the computer system 1000 may itself include a cloud-based computing environment, where the functionalities of the computer system 1000 are executed in a distributed fashion. Thus, the computer system 1000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 1000, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, systems and methods for multi-layer caching of data are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for multi-layer caching of data, the system comprising:
at least one processor; and
a memory communicatively coupled to the processor, the memory storing instructions executable by the at least one processor to perform a method comprising:
creating a data structure on top of an information retrieval library, the data structure being designed to access data associated with the information retrieval library through a local index;
creating a plurality of ordered cache layers for the data accessed via the local index, wherein the plurality of ordered cache layers are ordered based on frequency of access and a last layer is used to access the data over a network;
receiving a search query;
determining that the search query is for the data associated with the last layer; and
using the local index, executing the search query locally to retrieve a matching document from the data associated with the last layer remotely.

2. The system of claim 1, wherein more frequently accessed parts of the data are stored primarily locally and less frequently accessed parts of the data are stored primarily remotely.

3. The system of claim 1, wherein, upon creating the local index, the information retrieval library creates files on a local disk, each file of the files having a specific format to optimize different types of search queries.

4. The system of claim 2, wherein, when the search query is executed, the files are accessed depending on a type of data indexed and a type of a search performed.

5. The system of claim 2, wherein the less frequently accessed parts are evicted from the local disk and associated with the last layer based on age.

6. The system of claim 3, wherein nodes of the last layer share the local index, the local index being used to store beginnings and ends of the files.

7. The system of claim 3, wherein the files are available in the local index and are automatically replicated within a cluster, the files being available when a node of the last layer opens the local index, thereby speeding up startup time of opening the local index.

8. The system of claim 3, wherein every node of the last layer includes a second layer of cache for caching the files on the local disk.

9. The system of claim 1, wherein, upon access of the matching document stored remotely, larger parts of the document are cached locally in anticipation of further access.

10. A method for multi-layer caching of data, the method comprising:
creating a data structure on top of an information retrieval library, the data structure being designed to access data associated with the information retrieval library through a local index;
creating a plurality of ordered cache layers for the data accessed via the local index, wherein the plurality of ordered cache layers are ordered based on frequency of access and a last layer is used to access the data over a network;
receiving a search query;
determining that the search query is for the data associated with the last layer; and
using the local index, executing the search query locally to retrieve a matching document from the data associated with the last layer remotely.

11. The method of claim 10, wherein more frequently accessed parts of the data are stored primarily locally and less frequently accessed parts of the data are stored primarily remotely.

12. The method of claim 10, wherein, upon creating the local index, the information retrieval library creates files on a local disk, each file of the files having a specific format to optimize different types of search queries.

13. The method of claim 11, wherein, when the search query is executed, the files are accessed depending on a type of data indexed and a type of a search performed.

14. The method of claim 11, wherein the less frequently accessed parts are evicted from the local disk and associated with the last layer based on age.

15. The method of claim 12, wherein nodes of the last layer share the local index, the local index being used to store beginnings and ends of the files.

16. The method of claim 12, wherein the files are available in the local index and are automatically replicated within a cluster, the files being available when a node of the last layer opens the local index, thereby speeding up startup time of opening the local index.

17. The method of claim 12, wherein every node of the last layer includes a second layer of cache for caching the files on the local disk.

18. The method of claim 10, wherein, upon access of the matching document stored remotely, larger parts of the document are cached locally in anticipation of further access.

19. The method of claim 11, further comprising using a Least Frequently Used (LFU) algorithm to keep the more frequently accessed parts of the data in a local cache while evicting less frequently accessed parts of the data to a remote storage.

20. A non-transitory computer-readable storage medium having embodied thereon instructions, which when executed by at least one processor, perform steps of a method, the method comprising:
creating a data structure on top of an information retrieval library, the data structure being designed to access data associated with the information retrieval library through a local index;
creating a plurality of ordered cache layers for the data accessed via the local index, wherein the plurality of ordered cache layers are ordered based on frequency of access and a last layer is used to access the data over a network;
receiving a search query;
determining that the search query is for the data associated with the last layer; and
using the local index, executing the search query locally to retrieve a matching document from the data associated with the last layer remotely.
